(19) United States
(12) Patent Application Publication
(10) Pub. No.: US 2021/0179159 A1
(43) Pub. Date: Jun. 17, 2021

(54) LSM Luggage Trolleys: Intelligent Shopping Mall Luggage Trolleys

(71) Applicants: Surbhi Bhatia, Hofuf (SA); Rajendra Kumar Bharti, Almora (IN); Mohammad Tabrez Quasim, Bisha (SA); Mohammad Ayoub Khan, Bisha (SA); Meghna Chhabra, Faridabad (IN); Swati Chandna, Heidelberg (DE); Shadab Alam, Jazan (SA); Vipin Jain, Moradabad (IN); Pawan Kumar Bharti, Greater Noida (IN); Beg Raj, Varanasi (IN)

(72) Inventors: Surbhi Bhatia, Hofuf (SA); Rajendra Kumar Bharti, Almora (IN); Mohammad Tabrez Quasim, Bisha (SA); Mohammad Ayoub Khan, Bisha (SA); Meghna Chhabra, Faridabad (IN); Swati Chandna, Heidelberg (DE); Shadab Alam, Jazan (SA); Vipin Jain, Moradabad (IN); Pawan Kumar Bharti, Greater Noida (IN); Beg Raj, Varanasi (IN)

(21) Appl. No.: 17/164,845

(22) Filed: Feb. 2, 2021

(51) Int. Cl. B62B 5/00; G06K 9/62; G06K 9/00; G06F 3/14; H04R 1/10; G06F 3/16; G08B 5/36; H04W 4/80; H04W 76/11; G06Q 20/20; G06K 7/10; G06Q 20/36; G16H 50/80; G06N 20/00; G05D 1/02; G01G 19/12; G07D 11/00; B62B 5/06; B62B 3/14

(52) U.S. Cl. CPC B62B 5/0096; G06K 2007/10504; G06K 9/00664; G06F 3/14; H04R 1/10; G06F 3/167; G08B 5/36; H04W 4/80; H04W 76/11; G06Q 20/208; G06K 7/10861; G06Q 20/209; G06Q 20/36; G06Q 20/204; G16H 50/80; G06N 20/00; G05D 1/0214; G01G 19/12; G07D 11/009; B62B 5/06; B62B 3/1424; G06K 9/6267

(57) ABSTRACT

Nowadays shopping in supermarkets, malls, marts and other commercial places becomes a very important part of human life. Apart from just shopping, these places offer so many entertainment platforms for every age group of people under one roof. Therefore, to attract the customers, the shop owners are always trying to introduce unique flavour in their shopping platforms, such as: Digital Payment methods, Automatic controlling systems, location indicator of the particular store, Smart Trolley and etc. Shopping Trolley is always hidden but a very crucial part of your shopping. Here, we are putting this hidden component into the central attraction for the shopping. In our proposed invention idea (Smart Trolley), we are planning to put so many customer friendly features into the trolley, which takes the customer's shopping experience into another level. In our proposed Smart Trolley system, we are planning to incorporate smart lock, smart pooling, product scanners, location indicator, weighing machine, e-payment system and product reminder/assistant. In the Covid-19 pandemic, technology has played a very important role in the smooth run of human life and it has also convinced the young as well as old people to make their life align with the recent advancements. With this emphasis, our invention, “Smart Trolley” will give the smart, safe and secure shopping experience to the customers as well as store owners too. Business retail's owners can also adapt the proposed system in their business platforms because the implementing cost will also be adjusted in the long run as the proposed system will help to reduce the supporting staff size.

### FIELD OF THE INVENTION

The proposed invention of “LSM Luggage Trolleys” is not just a shopping trolley or automated moving trolley. This idea is much bigger than that. It is related to the smart way of offline shopping and digital financial transactions between the customers and the store owners. The proposed invention will help to connect each customer present in the shopping premises to its centralized system and it will play a role like a personal but virtual shopping assistant. The proposed invention will help to run the shopping places at the minimum supporting staff hence the store operating cost will come down. As a result of reduced supporting staff and thermal scanner mounted in the trolley, the proposed invention provides safe and secure shopping experience in this Covid 19 pandemic. Furthermore, the proposed system will help the customers to recall his/her last shopping history using a strong Database management system of the store.

### BACKGROUND OF THE INVENTION

The invention relates to location tracking and in particular to tracking customer location in a supermarket environment, other retail environments, or the like. The invention has particular although not exclusive relevance to an apparatus for location finding and tracking using an intelligent wheel for a shopping trolley where conventional location finding apparatus, such as global positioning system (GPS) technology or the like cannot be used effectively (e.g. indoors).

Supermarkets and other retail businesses employ various methods for monitoring customers' shopping habits in order to be able to offer them personalised offers and in turn to increase sales. The most common way of monitoring shopping habits is by inviting customers to join loyalty schemes and to use a unique identifier (such as a customer number/loyalty card) at checkout.

Studies have shown that impulse purchases account up to 40% of all supermarket sales (even very conservative estimates put the figure at 20%). In response to these studies, retailers work hard to suggest items and make offers clear to customers at all stages of the shopping process. It is therefore important for retailers to know (apart from the goods purchased) what products their customers did not buy but which they may have considered buying and/or might be particularly interested in. Using this insight, retailers are able to appeal to their customers' needs more efficiently and improve various aspects of their shopping experience. For example, retailers can further improve personalisation of offers for their customers, improve inventory handling/product availability, and generally augment their sales strategies based information about their customers. Whilst loyalty schemes provide a good understanding of customers' purchases, including impulse purchases that have been made by them, it is difficult for retailers to identify items that the customers did not buy but which they might be interested in buying in the future.

Other than costly and often ineffective customer surveys, a list of potential goods that a customer considered buying can be implied by tracking the customer's location within a store and by comparing the list of items purchased by that customer with the areas of the store (and any goods displayed in such areas) where the customer has spent time. Goods displayed at areas where a particular customer has spent some time but that do not appear on the customer's list of purchased items may be indicative of a missed sales opportunity. Retailers are thus very keen on identifying such items and turning any missed opportunities into a future sale (either through general and/or personalised offers).

There are systems that are designed to determine a customer's position within a particular store using cameras, which may be further enhanced in order to be able to distinguish between individual customers. However, these camera systems mainly focus on tracking heat maps of general customer activity within isolated areas of the store rather than individual customer tracking. Further, the more customers there are in a store, the more difficult it is for camera-based systems to distinguish one customer from another. It is now commonplace for mobile telephones and other portable computational devices to include location finding and related features, such as Global Positioning System (GPS) for tracking a user's position, and electronic compasses in the form of magnetometers for direction finding.

There are various systems that rely on navigation capabilities of customers' mobile telephones to track customer location and movement within a store, although GPS tracking is not possible in most retail environments (i.e. enclosed/indoor retail environments) and other features of the phone have to be used to enable such functionality. Such systems typically require customers to install and use a dedicated application on their mobile telephones. However, it is difficult to ensure compatibility with every type of mobile telephone that the customers may use. Compatibility issues notwithstanding, such dedicated applications generally result in a relatively low level of engagement from the customer's part (as for each retailer there may be a separate, retailer-specific application that needs to be installed and running on the customer's mobile telephone). Whilst such mobile telephone based tracking may be used to derive a list of potential items that the customer is interested in, user consent may often be required to the use of any tracking features provided by such applications.

Even when the customer consents to tracking his/her location, in the absence of satellite (such as GPS) based input, the localisation tends to be unreliable (or even impossible) indoors to an accuracy required for many typical use cases. Some of the drawbacks associated with such tracking solutions may be mitigated by using non-satellite based wireless capabilities (e.g. Bluetooth/Wi-Fi) of the customer's mobile telephone together with wireless transceivers installed at known locations within an area to be tracked (e.g. within a store). Such wireless transceivers may be referred to as ‘ranging beacons’ or simply ‘beacons’. In this case, an application running on the customer's mobile telephone may determine the mobile telephone's (and hence the customer's) current position by triangulation, i.e. based on the distance between the mobile telephone and one or more of such beacons.

However, whilst mobile phones can be used to triangulate position using signal strength measurements, this alone does not currently provide sufficient accuracy to determine detailed customer information (e.g. which products they spent significant time in front of). Indeed, the accuracy (˜3 m) achieved by current systems would likely struggle to confirm even which aisle a customer was in.

Further, such approaches also do not overcome other drawbacks generally associated with mobile telephone based solutions, such as a low level of user engagement arising, for example, from the potential need to obtain user consent to tracking, from a reluctance by a user to install an application on their mobile phone for every store they use, and/or simply from a forgetfulness to switch on and use the application. Generally, customers are becoming more and more aware of privacy and, as a result, are increasingly likely to object to being tracked using their own hardware. Whilst asking permission to use a customer's own device for location tracking is not currently a legal requirement in many countries, tracking in the absence of consent can frustrate and annoy customers thereby decreasing customer experience quality and damaging retailer reputation. It is, of course, a possibility that permission will become a requirement in the future even where it is not already a requirement.

Furthermore, in order to maintain accurate position tracking using conventional wireless technologies (such as GPS/Bluetooth/Wi-Fi), a relatively significant amount of energy is needed. This is a particular issue for portable devices such as mobile telephones, in which it is important to keep energy usage as low as possible in order to preserve battery life. Thus, if a customer starts an app then it will likely consume battery resources on their device whilst tracking their location which would be a significant inconvenience to the customer thereby making the customer less likely to choose to turn the application on.

Moreover, such approaches do not address the difficulties arising from the need for compatibility with the many types of mobile telephones used by the customers. Accordingly, preferred embodiments of the present invention aim to provide methods and apparatus which provide reliable customer tracking that overcomes or at least alleviates one or more of the above issues. In one aspect, the invention discloses a cart for carrying items, the cart comprising at least one-wheel comprising: means for acquiring information representing a rotational distance travelled by the wheel; and means for outputting information acquired by said acquiring means for estimating a change in a position of the cart based on said information acquired by said acquiring means.

The cart may further comprise means for determining a bearing of the wheel during motion, in which case the information outputting means may be operable to output information acquired by said acquiring means for estimating a change in a position of the cart based on said information acquired by said acquiring means and said bearing determined by said determining means. The cart may further comprise means for estimating a change in a position of the cart based on said output information acquired by said acquiring means and a bearing determined by said determining means.

The cart may further comprise means for communicating wirelessly (e.g. using a Bluetooth and/or a Wi-Fi based communication technology) with at least one of: another cart; a localisation beacon; and server apparatus. In one aspect, the invention discloses a wheel for the above described cart, wherein said wheel comprises said means for acquiring information representing a rotational distance travelled by the wheel. The wheel may further comprise means for determining a bearing of the wheel during motion, in which case the information outputting means may be operable to output information acquired by said acquiring means for estimating a change in a position of the cart based on said information acquired by said acquiring means and said bearing determined by said determining means. The wheel may further comprise means for estimating a change in a position of the cart based on said output information acquired by said acquiring means and a bearing determined by said determining means.

The information acquiring means may comprise at least one sensor. In this case, at least one sensor may comprise at least one of: a rotary encoder, a gyroscope, a magnetometer, and an accelerometer. The wheel may further comprise means for communicating wirelessly with at least one of: another wheel of a cart; a localisation beacon; and server apparatus. The communicating means may be operable to communicate using Bluetooth and/or a Wi-Fi based communication technology. The wheel may further comprise means for generating power for powering at least said information outputting means. The power generating means may be operable to generate power during rotation of said wheel.

### PRIOR ART SEARCH

US20050027443A1 *2003-07-302005-02-03 International Business Machines Corporation Shopper tracker and portable customer service terminal charger.
WO2006102183A2 *2005-03-182006-09-28 Gatekeeper Systems, Inc. Two-way communication system for tracking locations and statuses of wheeled vehicles.
US20120158297A1 *2010-12-202012-06-21 Electronics And Telecommunications Research Institute indoor location recognition system and indoor location recognition method using the same.
U.S. Pat. No. 5,576,691A *1995-01-121996-11-19 Polytracker, Inc. Method and apparatus for deterring theft of manually operated wheeled vehicles.
FR2799853B1 *1999-10-132002-02-01 Holy Dis Location of a mobile trolley.
KR20060123799A *2005-05-302006-12-05 The worked an advertisement, pos and navigation integrated cart.
CN101975585B *2010-09-082012-02-01 Strap-down inertial navigation system large azimuth misalignment angle initial alignment method based on MRUPF (Multi-resolution Unscented Particle Filter).
U.S. Pat. No. 9,513,127B2 *2011-12-222016-12-06 AppLabz, LLC Systems, methods, and apparatus for providing indoor navigation.
CN203255234U *2013-04-092013-10-30 Supermarket shopping trolley with electricity generation function.
US772734A *1904-04-271904-10-18 Edmund C Morgan Gathering-locomotive for mine-haulage systems.
U.S. Pat. No. 1,133,734A *1914-09-241915-03-30 Bernarr McFadden Railway system.
U.S. Pat. No. 2,320,150A *1940-07-091943-05-25 William R Lock ridge Code selective apparatus.
U.S. Pat. No. 2,799,186A *1956-04-161957-07-16 Leblond Mach Tool Co R K Cable carrier for long bed machine tools.
U.S. Pat. No. 2,904,197A *1954-07-131959-09-15 Bernard B Asheim Self-propelled mechanical parking mechanism with elevator.
U.S. Pat. No. 3,240,291A *1965-02-101966-03-15 Sidney H Bingham Vehicle braking system.
U.S. Pat. No. 3,480,162A *1967-02-271969-11-25 Triax Co Print-out device for warehousing system.
U.S. Pat. No. 3,632,906A *1970-09-141972-01-04 Caterpillar Mitsubishi Ltd Cable winder on trac.
U.S. Pat. No. 781,146A *1904-05-071905-01-31 Theodore A Johnson Roadway and vehicle for traveling thereon.
U.S. Pat. No. 867,765A *1907-02-191907-10-08 William H Strickler Automatic steering mechanism for vehicles.
U.S. Pat. No. 927,517A *1909-05-221909-07-13 Frank R Fageol Pleasure-railway.
U.S. Pat. No. 933,914A *1909-03-081909-09-14 Asa G Neville Automobile scenic railway.
U.S. Pat. No. 958,160A *1909-07-311910-05-17 Asa G Neville Gravity-automobile.
GB102385A *1915-11-241917-03-29 August Scherl Improvements in or relating to Steering Apparatus for Motor Vehicles.
U.S. Pat. No. 1,446,784A *1922-05-241923-02-271nt Motor Co Motor truck and track structure for motor trucks.
GB299756A *1927-07-301928-10-30 David De Forest More house.
S4268049A *1979-02-011981-05-19 Salvador Thomas RS shopping cart.
EP0161890A2 *1984-05-041985-11-21B. Houston Rehrig Plastic wheeled cart chassis.
GB2177354A1985-07-031987-01-21 John Nicholas Clegg Shopping trolleys.
EP0222480A1 *1985-10-021987-05-20 Madj Silver Shopping cart.
U.S. Pat. No. 4,746,134A *1985-05-031988-05-24 Houston Rehrig Plastic wheeled cart chassis having a reinforced structure.
WO1993011018A1 *1991-12-021993-06-10 I.C.D. Holding Method for producing a trolley made of a synthetic material.
U.S. Pat. No. 5,289,936A *1992-03-101994-03-01 Unr Industries, Inc. Plastic basket.
U.S. Pat. No. 5,368,318A *1992-12-111994-11-29 Houston Rehrig Collapsible child seat assembly for cart.
U.S. Pat. No. 5,613,696A *1994-03-041997-03-25 Policad Industrial, S.L. Shopping trolley for supermarkets and the like.
WO1997030880A11996-02-231997-08-28 Comital S.R.L. Supermarket trolley.
U.S. Pat. No. 5,769,435A *1995-02-281998-06-23 Yamato Sangyo Kabushiki Kaisha Shopping cart having a basket and basket vertical sidewall used therein, as well as method of assembling said basket.

### OBJECTIVES OF THE INVENTION

The main objective of the proposed invention idea is to provide a Safe, Secure, Serviceable, Swift and comfortable offline shopping/selling experience to the customers as well as store owners too. Presently, a significant percentage of the world's population (customer as well as store owner) experiencing offline shopping is an inevitable and time-consuming chore. The reasons are here:
1. Retrieving a shopping trolley at the store, and pushing the trolley up and down different aisles of the store.
2. Considerable amount of time taking search of particular stores or shopping sections (Grocery section, Food section, Electronics section, Kitchen section, Fashion section, cloth section, Game/Entertainment section and other sections).
3. Language or hesitation barrier between the customer and the supporting staff of the store.
4. Annoying time taking billing and payment procedure
5. Customer's inclination toward the online shopping especially in the Covid-19 Pandemic
6. To address all the above mentioned issues, the proposed system idea provides a comprehensive and effective solution for the customers as well as the store/supermarket owners too. The objectives of the proposed invention idea are listed here:
7. The objective of the proposed invention idea is to install a smart locking system to retrieve or drop a shopping trolley at the predefined location of the store. The smart lock of trolley can be unlocked through various schemes like: (i) by entering token money in the collection system of the lock (ii) by smart/master card of customer/support staff of the supermarket. This smart locking system motivates the customers (by offering the money cashback or return back the deposit token money) to drop the trolley at the predefined location after the shopping. This locking system also helps to connect the customer with the centralised server system of the store after registering his/her mobile number.
8. The other objective of the proposed invention idea is to wherein the one or more optical sensors are visual code scanners and cameras, positioned to scan the items as the items enter the basket. The first electronic signals include: signals indicative of reflected light and digital images, respectively. The processing unit is configured to facilitate the classification of the items, processing the signals, accessing a database of codes and processing of digital images using an object recognition technique or machine learning model or machine learning model.
9. The other objective of the proposed invention idea is to install the intelligent wheels for the movement of trolleys in automatic nature. These intelligent wheels are controlled by bluetooth connection, which is setup between the smart trolley and customer's mobile phone after verifying the unique key sequence mentioned on the trolley and OTP received in the registered mobile number. After successful bluetooth connection setup, the intelligent wheels are ready to follow or tracing the customer's movement. The wheels include a weight sensing component that generates the second electronic signals corresponding to weights of the items when resting in the basket.
10. The other objective of the invention is to wherein: at least one of the two or more wheel assemblies includes a respective weight sensing component; and the processing unit is configured to facilitate classification of the items scanned by the at least one optical sensor at least in part by processing (i) the first electronic signals generated by the at least one optical sensor and (ii) second electronic signals generated by at least one of the one or more weight sensing components and indicative of weights of the items when resting in the basket.
11. The other objective of the invention idea is to wherein the processing unit is configured to trigger an audible signal when, for a given item being placed in the basket, the processing of the first electronic signals and the second electronic signals indicates that the given item is associated with only a single item type.
12. The other objective of the proposed invention idea is to connect the customer with the centralised server of the supermarket or business retail after verifying the registered mobile number and to provide all the required information to the customer that he/she wants in their language or dialect. Additionally, this system will assist the customer in the shopping or suggest the item type to the customer or work as a location indicator to indicate the particular store/item's location in the supermarket.
13. The other objective of the proposed invention idea is to display the list of items with their price at the display device mounted in the trolley and to save the shopping history into the store's database.
14. The other objective of the proposed invention is to suggest the items using machine learning models from past history.
15. The other objective of the proposed invention idea is to induct the swift and secure e-bill generation and digital payment system.
16. The other objective of the invention idea is to lessen the additional financial investment in the store operating cost with the proposed system.
17. The other objective of the invention idea is to restrict customers/staff from entering supermarkets/stores through Covid 19 thermal scanner to control the spread of Covid-19 pandemic and to provide a safe and secure shopping experience.

### SUMMARY OF THE INVENTION

The aim of the proposed invention idea is to make offline shopping more customer friendly, entertaining, safe and secure shopping experience for the customers as well as sellers too. The invention aims at obtaining an improvement over such known trolleys, in particular regarding the economy in the manufacture of its parts and the assembly thereof. A particular aim of the invention is to reduce the mass of the trolley, and consequently the material required for its production, eliminating parts which are accessory or redundant for purposes of the stability and structural strength of the trolley.

An additional particular aim of the invention is to obtain a carriage of the type defined above in which the union between the support of the base and the basket is achievable without using auxiliary retaining organs, and in simple, easily automated ways.

Another particular aim of the invention is to obtain a trolley of the type defined above provided with an essential structure, hence it easily scanned and automatically enlist and verifying the item type on the basis of information fetched from the data server before generating the bill and execute the swift and secure digital payment procedure.

Another particular aim of the invention is to obtain a trolley of the type defined above provided with an essential structure, hence easily or automatically manoeuvred by users and by the personnel of the supermarket within which it is employed.

Another particular aim of the invention is to obtain a trolley of the type defined above provided with an essential structure, hence it easily retrieves the trolley and will motivate the customer to drop the trolley at the particular location after the shopping. It also controls the covid 19 spread by restricting the entry of the suspected covid infected people.

According to the invention, these and other aims are achieved thanks to the fact that the two lateral uprights and the aforesaid end of the basket have respective mutually facing surfaces formed substantially with comb like formations, mutually complementary and mutually meshing by effect of a relative coupling between said basket and said support when the trolley is assembled. The comb like formations advantageously comprise a plurality of elongated projections, generally in said direction of coupling and possibly slightly angled relative thereto.

### BRIEF DESCRIPTION OF THE DRAWINGS

The figures described below depict various aspects of the systems and methods disclosed herein. It should be understood that each figure depicts an embodiment of a particular aspect of the disclosed system and methods, and that each of the figures is intended to accord with a possible embodiment thereof.

FIG. 1-A: depicts an example smart shopping trolley that may be used to facilitate and expedite shopping tasks.

FIG. 1-B: depicts a smart shopping front view that consists of a smart display, token box, smart finger lock, payment terminal, thermal scanner, camera, barcode scanner etc.

FIG. 2 is a schematic perspective view of a supermarket trolley (Prior art search)

FIG. 2-A is an exploded view of FIG. 1. (Prior art search)

FIG. 3: Depict example handle assemblies that may be used with a smart shopping trolley.

FIG. 4: is a block diagram of an example system in which a smart shopping trolley may be used.

FIG. 5: depicts the Scanless recognition technique.

FIG. 6: depicts an in store navigation system.

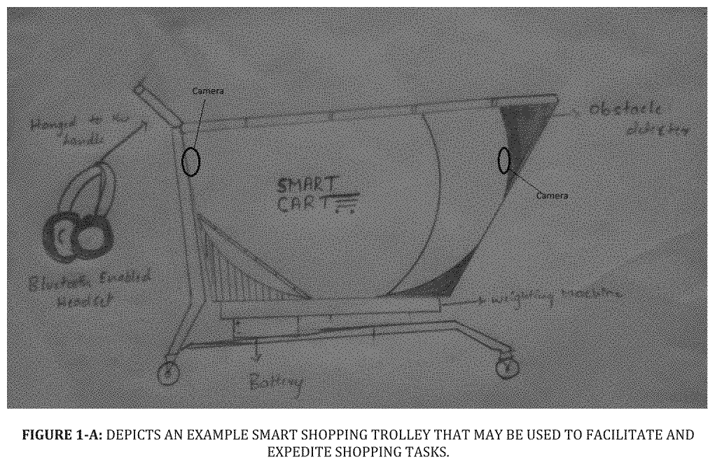

### DETAILED DESCRIPTION OF THE INVENTION

With reference to the drawings, the number 1 globally designates a supermarket trolley according to the invention essentially comprising a base 2 and a basket container 3. The base 2 is constituted by a single piece of moulded plastic material defining a structure substantially shaped as a double “L”, with two horizontal branches 4 anteriorly connected to each other by a short transverse member 5 and posteriorly joined to two substantially vertical uprights 6 mutually distanced and separated, extending upwards with a slight curvature.

Wheels at least partly capable of swiveling 7 are positioned respectively underneath the external ends of the horizontal elements 4 and underneath the lower ends of the uprights 6. The number 28 indicates a shelf fitted between the two horizontal elements 4, behind the transverse member 5. Below the comb like formation 10 the inner surface 8 of each upright 6 is formed with two seats, respectively upper seat 11 and lower seat 12 having for instance broadly quadrangular section, whereof the upper seat 11 is slighting more rearwards and has smaller dimensions than the lower seat 12.

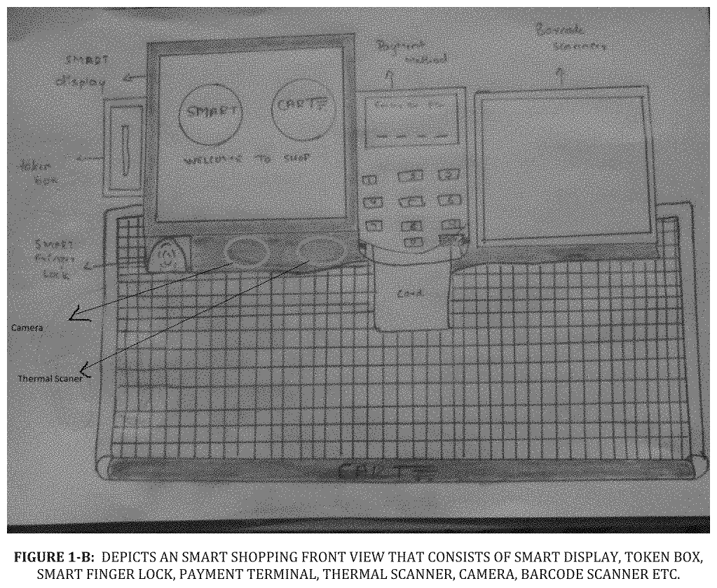

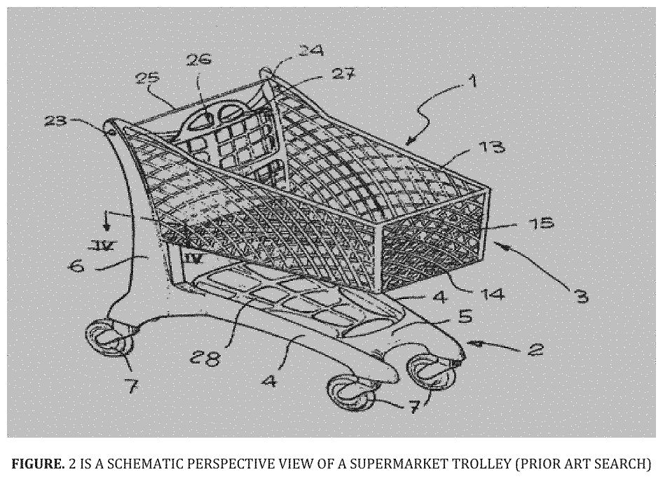

The basket container 3 is also formed by a single piece of moulded plastic material with lateral walls 13, bottom wall 14 and front wall 15 with grid configuration. As FIG. 2 shows, the basket 2 is open posteriorly and is formed with two elongated elements 16 which extend inferiorly underneath its bottom wall 14 with respective legs 17. Each element 16 is formed in correspondence with its exterior surface 19 with a plurality of elongated integral projections 18 substantially identical to the projections 9 of the uprights 6 and positioned in complementary fashion thereto. Said projections 18 constitute respective comb like formations 20 able to co-operate, in a manner explained below, with the comb like formations of the base 2.

Moreover, each elongated element 16 is formed with a pair of projections, respectively upper projection 21, located immediately below the related comb like formation, and lower projection 22, positioned at the lower end of the related leg 17. The projections 21 and 22 have shapes corresponding to those of the seats 11 and 12 of the uprights 10, and are arranged complementarily thereto. Said projections 21 and 22 are formed integral by moulding with the elongated elements 16.

The reference numbers 23, 24 designated through holes provided in proximity to the upper ends of the uprights 6 and of the elongated elements 16, and whose function is to allow the passage of a transverse bar 25, in the manner explained below. The number 26 globally indicates a child seat assembly constituted by a backrest part 27, by a seat part 28 and by a wall 29 which posteriorly closes the basket 3, between the two uprights 6. The function of the comb-like formations 10, 20 and of the groove and tongue organs constituted respectively by the seats 11, 12 and by the projections 21, 22 is to obtain, when the trolley 1 is assembled, a stable union between the basket 3 and the base 2 in such a way as to complete their respective load-bearing structures as a result of their mutual union.

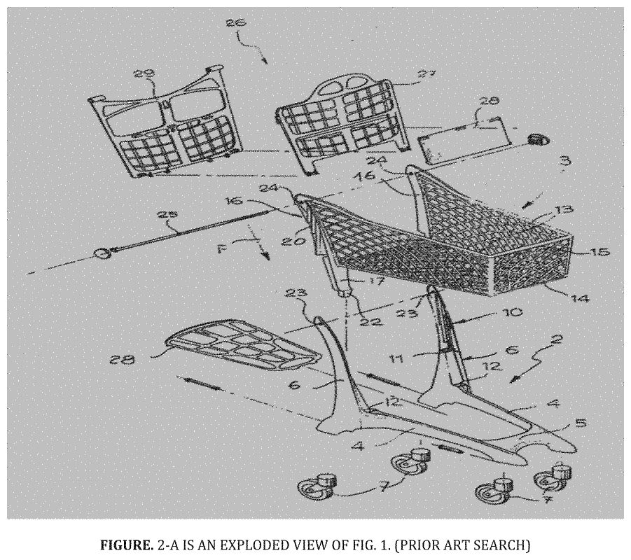

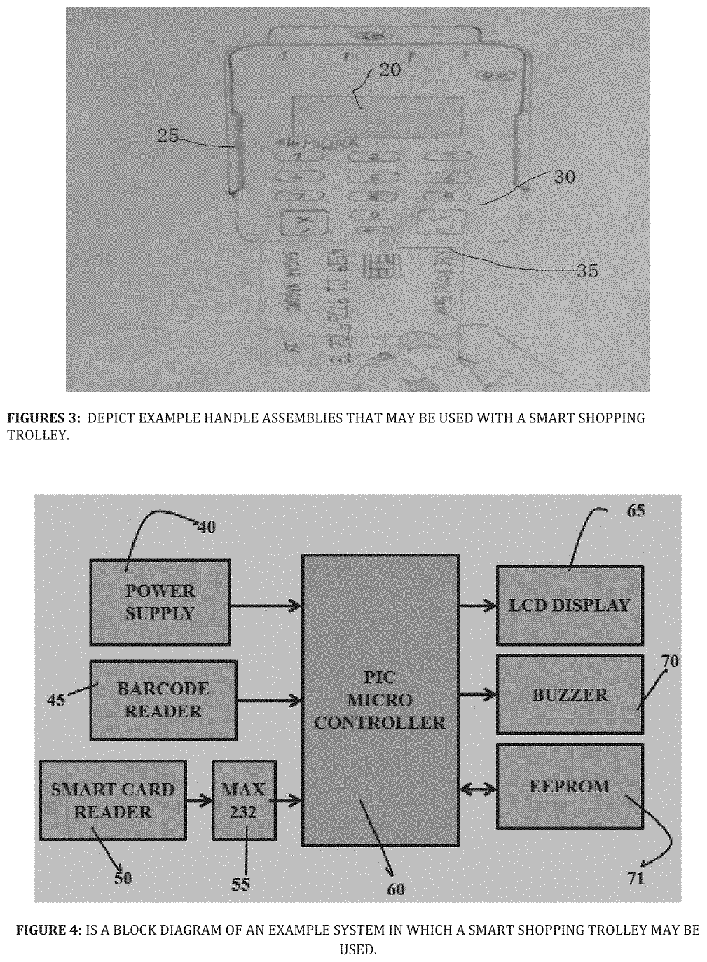

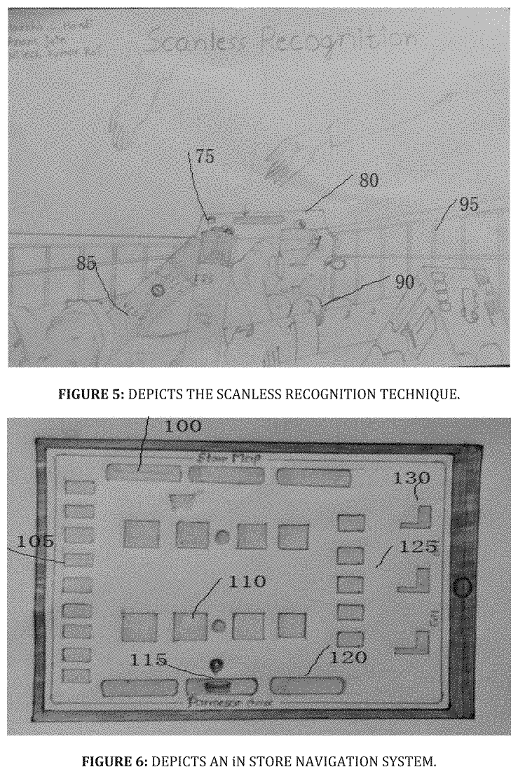

Said union is accomplished by effect of a relative coupling motion between the basket 3 and the base 2 along a direction of coupling (indicated by the arrow F in FIG. 2), substantially parallel to the uprights 6, in such a way as to obtain the coupling between them and the elongated elements 16 of the basket 3. Said coupling occurs by effect of the mutual meshing between the comb like formations 10 and 20, whose projections 9 and 18 slide on each other, positioning themselves in the manner shown in FIG. 4, and of the subsequent insertion of the projections 21 and 22 into the seats 11 and 12. At the end of this operation, the basket 3 is stably and firmly fastened relative to the base 2, projecting in overhang from the uprights 6 above the shelf 28 with no need to use auxiliary locking elements.

The assembly is completed by effect of the introduction of the transverse bar 25 through the holes 23 and 24, and of its axial locking in tie rod like fashion in a manner not described in detail, but readily apparent to those versed in the art. The bar 25, whereto the rear wall 29 of the seat assembly 26 is suspended, prevents disengagement between the basket 3 and the base 2 and will normally constitute the support for a tubular handle (not shown herein) for manoeuvring the trolley 3, as well as for a possible token-operated lock for connection to identical trolleys 3 in an aligned, mutually meshed condition.

Naturally, the construction details and the embodiments may be varied widely from what is described and illustrated herein, without thereby departing from the scope of the present invention as defined in the claims that follow. Thus, for instance, the seats 11, 12 and the corresponding projections 21, 22 could be inverted, placing the former on the longitudinal elements 16 of the basket 3 and the latter on the uprights 6.

Moreover, the projections 9, 18 of the comb-like formations 10 and 20 could have a more or less oblique conformation relative to the direction of coupling F, and they may also exhibit a slight curvature, and said direction of coupling F could also be different from the one indicated herein, i.e. not necessarily parallel to the uprights 6 and not even necessarily linear.

The power unit includes one or more photovoltaic elements of the handle assembly component, the one or more photovoltaic elements being configured to generate electricity in response to light impinging upon the one or more photovoltaic elements; and/or the power unit includes a motion powered unit within at least one of the one or more wheel assembly components, the motion powered unit being configured to generate electricity in response to rotational movement of a wheel of the respective wheel assembly.

The invention is to further comprising an electronic display component coupled to the processing unit, wherein the processing unit is configured to cause the electronic display component to display (i) an item type corresponding to an item that was successfully classified by the processing unit, and/or (ii) a total cost of all items that were successfully classified by the processing unit in a given shopping session. A shopping trolley comprising: a basket including a basket floor and a plurality of basket walls; two or more wheel assemblies each including a respective wheel; a chassis coupled to the basket and the two or more wheels' assemblies;

A handle assembly coupled to the basket and/or the chassis, wherein the handle assembly includes (i) a handle configured to be gripped by a person manually maneuvering the shopping trolley and (ii) one or more optical sensors; a processing unit configured to facilitate classification of items scanned by at least one of the one or more optical sensors, at least in part by (i) processing first electronic signals generated by the at least one optical sensor, or (ii) causing a transmitter of the shopping trolley to transmit the first electronic signals, or data derived therefrom, to a server; and a power unit configured to provide power to the processing unit and the one or more optical sensors, wherein at least one of the two or more wheel assemblies includes a respective additional optical sensor positioned to scan items within the basket.

The invention is to wherein at least one of the one or more optical sensors is positioned to scan the items as the items enter the basket. The invention is to wherein: the one or more optical sensors are visual code scanners; the first electronic signals include signals indicative of reflected light; and the processing unit is configured to facilitate classification of the items at least in part by (i) processing the signals indicative of reflected light to decode visual codes on packaging of the items, and (ii) accessing a database of codes corresponding to different item types.

The invention is to wherein: the one or more optical sensors are cameras; the first electronic signals include one or more digital images, and the processing unit is configured to facilitate classification of the items at least in part by processing the one or more digital images using a machine learning model that is trained to classify items according to item type. the invention is to wherein: at least one of the two or more wheel assemblies includes a respective weight sensing component; and the processing unit is configured to facilitate classification of the items scanned by the at least one optical sensor at least in part by processing (i) the first electronic signals generated by the at least one optical sensor and (ii) second electronic signals generated by at least one of the one or more weight sensing components and indicative of weights of the items when resting in the basket.

### Smart Shopping Trolley:

1. The present disclosure generally relates to shopping trolleys and, more specifically, to trolleys and related technologies that facilitate (e.g., reduce the amount of time required to perform) checkout and/or other shopping-related tasks.
2. For a significant percentage of the world's population, grocery shopping is an inevitable and time-consuming chore. Typically, a customer retrieves a shopping trolley (also referred to as a shopping “cart,” in some regions) at a store, and pushes the trolley up and down different aisles of the store in search of food, food-related or other items commonly found in supermarkets around the world (e.g., clothes, DIY (“do it yourself”) items, garden supplies, etc.). The customer may randomly roam the aisles in the hope of coming across items that he or she would like to purchase or, perhaps more commonly, may come to the store armed with a grocery list of items to buy. In the latter case, the customer may need to spend a considerable amount of time searching for items on the list, and/or may need to take the time to find and speak to a store employee for guidance.
3. When the customer does find a desired item, he or she picks up the item and places it in a basket of the trolley (e.g., the main compartment of the basket or, in some trolleys, a smaller, collapsible compartment near the handle), and proceeds to look for the next desired item. When the customer has finished and is ready to leave (e.g., after finding all food items on a grocery list), he or she typically pushes the trolley to a checkout area. This may be an area where a checkout attendant operates a register/terminal, for example, or may be a “self-checkout” payment station. In either case, queues of other customers can cause significant delays, especially at peak shopping times. If the customer goes to an attended checkout lane, he or she typically must take all items out of the trolley basket, and place them on a conveyor (or possibly a counter) to allow the attendant to scan barcodes on the items. Alternatively, if the customer goes to a self-checkout lane or area, he or she must personally scan each item, and place each scanned item in a bag in a designated area equipped with a weight sensor (for security purposes, to ensure that the item weight matches its expected weight). Either one of these procedures (i.e., regular/attended checkout or self-checkout) can cause a significant amount of additional delay, beyond that discussed above. Quite often, customers end up putting in far more effort, and spending far more time, at the grocery store than they would expect, leading to general dissatisfaction.
4. Similar sources of delay and dissatisfaction can occur in other retail shopping contexts, such as when shopping in so-called “big-box” stores (e.g., department stores), or any other type of store that utilizes conventional shopping trolleys and checkout procedures.
5. To solve this problem, we came up with a unique solution
6. Checkout Made Easy Just toss it in, and leave—With our next generation smart self-checkout cart, powered by deep learning & computer vision, items are instantly detected as they enter the cart. Customers can just toss the items in & leave the store
7. Scan—Scan the item barcode, and simply add it to the shopping cart. No app downloads necessary.
8. Pay—Once you have completed shopping, pay directly on the cart, with credit/debit or mobile payment.
9. Go—Remove your bagged items from the cart, skip the cashiers, and be on your way!
10. Covid 19 Thermal Scanner is also mounted on a trolley.

### General Steps of Smart Trolly Functioning:

Power on, trolley is ready to use for customers.

Trolley is ready to check the body temperature of customers through a thermal scanner mounted on it for Covid-19 preliminary test.

If customers passed the test, then, trolley asked to enter mobile number/email ID etc. for OTP verifications.

After OTP verification, trolley is connected to the centralised server for further assistance. Now, customers are allowed to enter supermarkets for shopping.

On the trolley screen, customers can search any product, sections, etc, as per their needs via audio voice search or writing on search section.

Trolley display can popup search results in the form of audio or visuals. The language is no barrier for shopping, so search results can be regional/Hindi/English language as per settings.

Further steps, customers will scan the selected item and place it in the basket. With the help of few electronic signals, it is confirmed that a given item is associated with only a single item type.

Once shopping has been completed, pay directly on the cart, with credit/debit or mobile payment.

Remove bagged items from the cart, skip the cashiers, and put the cart at right positions.

1. A smart trolley comprising:
a basket including a basket floor and a plurality of basket walls; two or more intelligent wheel assemblies each including a respective wheel with an obstruct sensor.
a chassis coupled to the basket and to the two or more intelligent wheel assemblies and to the smart locking system with token money collection/return box;
a handle assembly coupled to the basket and/or the chassis, wherein the handle assembly includes:
i. a handle configured to be gripped by a person manually maneuvering the shopping trolley;
ii. a handle configured to be a bluetooth system which will connect the customer's mobile after verifying the registered mobile number and a unique trolley sequence number written on the handle, wherein the bluetooth connection and obstruct identifier sensor controlled the wheel's auto movement and guidance system;
ii. an additional structure extending from, and affixed to, the handle, wherein the additional structure includes one or more optical sensors and one or more photovoltaic elements, thermal scanner, speaker, and smart POS payment terminal;
a processing unit configured to facilitate classification of items scanned by the sensors, at least in part by:
i. processing first electronic signals generated by the at least one optical sensor, or a transmitter/receiver module of the shopping trolley to transmit the first electronic signals, or data to the centralised server, wherein photovoltaic elements are configured to provide power to the processing unit and the sensors, wherein the additional structure is an add-on structure positioned on or above a top side of the handle;
an electronic display component coupled to the processing unit, wherein the processing unit is configured to cause the electronic display component to display:
i. an item type corresponding to an item that is in the basket and was successfully classified by the processing unit, and wherein a total cost of all items that are in the basket and were successfully classified by the processing unit in a given shopping session;
a basket includes a green and red LED light which is connected with the processing unit to indicate the item rested in the basket is or isn't successfully classified by the processing unit.

2. The smart trolley according to claim 1, wherein at least one of the one or more optical sensors is positioned to scan the items as the items enter the basket, wherein the one or more optical sensors are visual code scanners; and the first electronic signals include signals indicative of reflected light and also the processing unit is configured to facilitate classification of the items at least in part by: processing the signals indicative of reflected light to decode visual codes on packaging of the items; and accessing a database of codes corresponding to different item types.

3. The smart trolley according to claim 1, wherein the one or more optical sensors are cameras; and the first electronic signals include one or more digital images and also the processing unit is configured to facilitate classification of the items at least in part by processing the one or more digital images using an object recognition technique and also the processing unit is configured to facilitate classification of the items at least in part by processing the one or more digital images using a machine learning model that is trained to classify items according to item type.

4. The smart trolley according to claim 1, wherein: at least one of the two or more intelligent wheel assemblies includes a respective weight sensing component; and the processing unit is configured to facilitate classification of the items scanned by the at least one optical sensor at least in part by processing (i) the first electronic signals generated by the at least one optical sensor and (ii) second electronic signals generated by at least one of the one or more weight sensing components and indicative of weights of the items when resting in the basket.

5. The smart trolley according to claim 1, wherein the processing unit is configured to trigger an audible signal and blow the LED light (red or Green color) when, for a given item being placed in the basket, the processing of the first electronic signals and the second electronic signals indicates that the given item is associated with only a single item type, wherein at least one of the two or more wheel assemblies includes a respective additional optical sensor positioned to scan items within the basket, and when items are successfully classified and included in the items list display at the display screen then green light will be blown otherwise Red LED will be blown, and the display screen is mounted on the basket's handle which will display all the items finally rested in the basket with their respective price, and after completing the shopping it displays the shopping bill and various payment options, and the display screen displays the particular store location as per the user's requirement.

6. The smart trolley according to claim 1, wherein the additional structure includes a substantially flat component extending from, and affixed to, the handle and also the shopping trolley further includes a battery backup unit configured to provide power to the processing unit and the one or more optical sensors, and wherein at least a portion of the processing unit is integrated within the handle assembly component.

7. The smart trolley according to claim 1, wherein a smart locking system is positioned to unlock the trolley after successfully performing the three mandatory actions, which are connected with the trolley processing unit, wherein the actions are:
i. passing the Covid 19 thermal scanner test
ii. verifying his registered mobile number
iii. enter the token money in the collection box
wherein the Covid 19 thermal scanner restricts the customer entry in the respective shopping premises and it helps to contain the Covid 19 spread, and wherein the scanner works as per the recommendations and guidelines of the respective health or medical organizations, and wherein after verification of the customer's mobile number, the particular trolley will be allocated to the respective customer and the trolley's local processing unit will have access to the centralized server system of the respective supermarket, and wherein after successfully passing the above two actions, customer have to enter pre-decided token money in the trolley's collection box, and wherein the token money is refunded only when the customer will drop the trolley at its respective location after completing the shopping process.

8. The smart trolley according to claim 1, wherein the transceiver module is positioned to set up the communication channel between the trolley's local processing unit and the respective server system and also the bluetooth module obstruct and other sensors are positioned to give commands to the intelligent wheel assemblies for the movement of trolleys in automatic nature, wherein the bluetooth module works after pairing up with the customer's mobile phone and helps to follow the customer movement.

9. The smart trolley according to claim 1, wherein the digital payment system like POS terminal or e-wallet is positioned to perform the secure and swift payment procedure, wherein the payment terminal is connected with the trolley local processing unit and the display screen, which will show the confirmation of the payment.

10. The smart trolley according to claim 1, wherein the headphone is positioned to answer the audio response of the customer's queries like, store location, discount information, product type, recent trend and so on) in his/her language or dialect, and wherein using the transceiver module, the local processing unit fetches the appropriate information from the centralised server system and sends it to the output terminals (display screen and Headphone), and wherein the headphone display screen and other proposed segments of this invention idea will collectively work as a virtual shopping assistant.
